(19) United States
(12) Patent Application Publication
(10) Pub. No.: US 2025/0266547 A1
(43) Pub. Date: Aug. 21, 2025

(54) BATTERY CASE AND ELECTRIC VEHICLE STRUCTURE

(71) Applicants: Hyundai Motor Company, Seoul (KR); Kia Corporation, Seoul (KR)

(72) Inventors: Tae Soo PARK, Seoul (KR); Gun Woo KO, Seongnam-Si (KR); Kyung Mo KIM, Hwaseong-Si (KR)

(73) Assignees: Hyundai Motor Company, (omitted); Kia Corporation, Seoul (KR)

(21) Appl. No.: 18/798,625

(22) Filed: Aug. 8, 2024

(30) Foreign Application Priority Data
Feb. 19, 2024 (KR) 10-2024-0023613

(51) Int. Cl. H01M 50/242; B60K 1/04; H01M 50/249; H01M 50/264; H01M 50/298

(52) U.S. Cl. CPC H01M 50/242; B60K 1/04; H01M 50/249; H01M 50/264; H01M 50/298; B60K 2001/0438; H01M 2220/20

(57) ABSTRACT

In a battery case and an electric vehicle structure including the same, the battery case includes a battery side member surrounding a side portion of a battery accommodation space formed by a lower case. The battery side member includes a side wall portion surrounding the side portion of the battery accommodation space, a first-step protrusion protruding outwards from an upper portion of the side wall portion, and a second-step protrusion protruding outwards from an upper portion of the first-step protrusion.

### CROSS-REFERENCE TO RELATED APPLICATION

The present application claims priority to Korean Patent Application No. 10-2024-0023613 filed on Feb. 19, 2024, the entire contents of which is incorporated herein for all purposes by this reference.

### BACKGROUND OF THE PRESENT DISCLOSURE

### Field of the Present Disclosure

The present disclosure relates to technology associated with a structure of an electric vehicle mounted with a battery pack.

### Description of Related Art

A battery pack is mounted in an electric vehicle to supply electric power required for driving of the electric vehicle.

The battery pack is mainly mounted at a lower portion of a vehicle body and includes a structure in which a plurality of battery modules is accommodated within a battery case. Each of the battery modules is constituted by a plurality of battery cells.

The battery case may be constituted by a lower case to surround lower and side portions of a battery accommodation space for accommodating battery modules therein, and an upper cover coupled to an upper side of the lower case to seal the battery accommodation space.

The lower case is provided with battery side members at opposite sides thereof. The battery side members may have both a function of surrounding the side portion of the battery accommodation space and a function of providing a mounting part for fixing a battery pack to a vehicle body.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a battery case and an electric vehicle structure which are configured for not only increasing the number of battery cells accommodated in the battery case, achieving an increase in driving range of the vehicle, but also efficiently absorbing collision energy generated when a lateral collision accident of the vehicle or the like occurs, effectively protecting the battery cells accommodated in the battery case.

In accordance with an aspect of the present disclosure, the above and other objects may be accomplished by the provision of a battery case including a battery side member surrounding a side portion of a battery accommodation space formed by a lower case, wherein the battery side member includes a side wall portion surrounding the side portion of the battery accommodation space, a first-step protrusion protruding outwards from an upper portion of the side wall portion, and a second-step protrusion protruding outwards from an upper portion of the first-step protrusion.

The battery side member may be formed by a member having a cross-section formed by the side wall portion, the first-step protrusion, and the second-step protrusion, to extend uniformly linearly.

The side wall portion may include a cross-section formed by a plurality of ribs disposed between a plurality of vertical walls while being spaced from one another in an first direction thereof.

A transverse member may be provided at the lower case to extend across the battery accommodation space in a second direction. A portion of the ribs of the side wall portion may be disposed at a level aligned with the transverse member.

The transverse member may include a top wall, and an intermediate rib spaced from the top wall in a downward direction while being parallel to the top wall. A portion of the ribs of the side wall may be disposed at levels aligned with the top wall and the intermediate rib of the transverse member, respectively.

The first-step protrusion may include an upper horizontal wall protruding from one vertical wall of the side wall portion in the second direction, a lower horizontal wall spaced from the upper horizontal wall in the downward direction to form a deformation absorption space therebetween, and an intermediate wall configured to interconnect an end portion of the upper horizontal wall and an end portion of the lower horizontal wall.

The intermediate wall may be formed to be inclined so that the intermediate wall extends toward the side wall portion while extending from an upper end portion thereof to a lower end portion thereof.

The lower horizontal wall may be disposed at a level aligned with the intermediate rib of the transverse member.

The second-step protrusion may be formed to protrude from the intermediate wall in the second direction. The second-step protrusion may include at least one reinforcement rib disposed in the second-step protrusion.

An additional side wall may be provided inside the side wall portion. The additional side wall may include a plurality of vertical walls, and a plurality of ribs disposed between the plurality of vertical walls while being spaced from one another in the first direction thereof.

A conduit mounting mechanism for cables and a conduit may be mounted to a lower portion of the second-step protrusion or the side wall portion under the first-step protrusion.

In accordance with another aspect of the present disclosure, there is provided an electric vehicle structure including a lower case including a battery side member having a cross-section formed by a side wall portion surrounding a side portion of a battery accommodation space, a first-step protrusion protruding outwards from an upper portion of the side wall portion, and a second-step protrusion protruding outwards from an upper portion of the first-step protrusion, the cross-section extending uniformly linearly, and a battery mounting bolt coupled to a side seal while extending through the second-step protrusion of the battery side member.

A side seal reinforcement may be mounted within the side seal. The battery mounting bolt may be coupled to the side seal reinforcement.

The lower case may be coupled to a vehicle body floor panel under the vehicle body floor panel so that the vehicle body floor panel covers an upper side of the battery accommodation space.

Opposite lateral end portions of the vehicle body floor panel may be coupled between at least one of the first-step protrusion and the second-step protrusion of the battery side member and the side seal while overlapping therewith.

A sealer for watertightness may be coated over an area where the lateral end portions of the vehicle body floor panel are disposed between the battery side member and the side seal while overlapping therewith.

A conduit mounting mechanism for cables and a conduit may be mounted to a lower portion of the second-step protrusion or the side wall portion under the first-step protrusion.

The first-step protrusion of the battery side member may include an upper horizontal wall protruding from a vertical wall of the side wall portion in the second direction, a lower horizontal wall spaced from the upper horizontal wall in the downward direction to form a deformation absorption space therebetween, and an intermediate wall configured to interconnect an end portion of the upper horizontal wall and an end portion of the lower horizontal wall.

The second-step protrusion of the battery side member may be formed to protrude from the intermediate wall in the second direction. The second-step protrusion may include at least one reinforcement rib disposed in the second-step protrusion.

The intermediate wall of the battery side member may be formed to be inclined so that the intermediate wall extends toward the side wall portion while extending from an upper end portion thereof to a lower end portion thereof.

The second-step protrusion of the battery side member may be disposed under the side seal reinforcement to overlap with the side seal reinforcement in an first direction thereof. The battery mounting bolt may be coupled to the side seal reinforcement while extending through the second-step protrusion. A lower end portion of the second-step protrusion may be disposed at a higher level than a level of a lower end portion of the first-step protrusion so that a head of the battery mounting bolt is disposed at a higher level than the level of the lower end portion of the first-step protrusion.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view explaining a structure of a vehicle to which the present disclosure is applicable;

FIG. 2 is a view showing a vehicle, to which the present disclosure is applied, through a cross-section taken along line II-II in FIG. 1;

FIG. 3 is a view showing a cross-section of a battery side member of FIG. 2 according to an exemplary embodiment of the present disclosure;

FIG. 4 is a view explaining mounting of a conduit mounting mechanism to the battery side member;

FIG. 5 is a view explaining a modified embodiment of a lower case according to an exemplary embodiment of the present disclosure; and

FIG. 6 is a view exemplarily illustrating addition of a conduit to a configuration of FIG. 2.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings, and the same or similar elements are designated by the same reference numerals regardless of the numerals in the drawings and redundant description thereof will be omitted.

Although “module” or “unit” is suffixed to constituent elements described in the following description, this is intended only for ease of description of the specification. The suffixes themselves have no meaning or function to distinguish the constituent element using the suffix from the constituent element using no suffix.

In the following description of the exemplary embodiments of the present disclosure, a detailed description of known functions and configurations incorporated herein will be omitted when it may obscure the subject matter of the exemplary embodiments of the present disclosure. Furthermore, the exemplary embodiments of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in an exemplary embodiment of the present disclosure.

It will be understood that, although the terms “first”, “second”, etc. may be used herein to describe various elements, these elements should not be limited by these terms. These terms are only used to distinguish one element from another.

In the case where an element is “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

Unless clearly used otherwise, singular expressions include a plural meaning.

In the present specification, the term “comprising”, “including”, or the like, is intended to express the existence of the characteristic, the numeral, the step, the operation, the element, the portion, or the combination thereof, and does not exclude another characteristic, numeral, step, operation, element, portion, or any combination thereof, or any addition thereto.

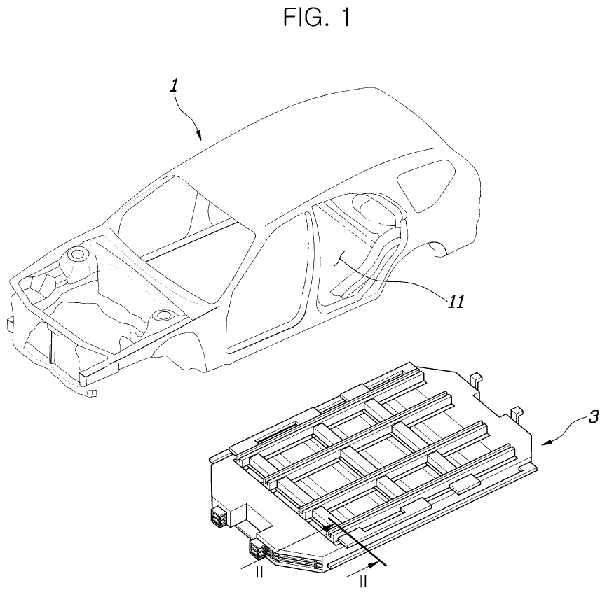

FIG. 1 is a view explaining a structure of a vehicle to which the present disclosure is applicable. In detail, FIG. 1 explains mounting of a battery pack 3 under a vehicle body 1.

For reference, the battery pack 3 is meant as including a plurality of battery modules 5 and a battery case 7 accommodating the battery modules 5.

The battery case 7 may include a lower case 9 configured to form a battery accommodation space 8 for accommodating the battery modules 5, and an upper cover. In FIG. 1, a cell-to-vehicle (CTV) design in which a vehicle body floor panel 11 is configured to finish an upper side of the battery accommodation space 8, in place of the upper cover, is illustrated.

That is, in accordance with the CTV design, the vehicle body floor panel 11 is configured to directly finish the upper side of the battery accommodation space 8, in place of a separate upper cover used in conventional cases, to enable the battery modules 5 to be directly provided at the vehicle body, for simplification of a vehicle structure and reduction in weight of the vehicle structure.

For reference, the present disclosure is not intended to be applicable only to vehicles including the above-described CTV design, but is also applicable to an independent battery pack using the battery case 7 including a conventional upper cover and a vehicle using the independent battery pack.

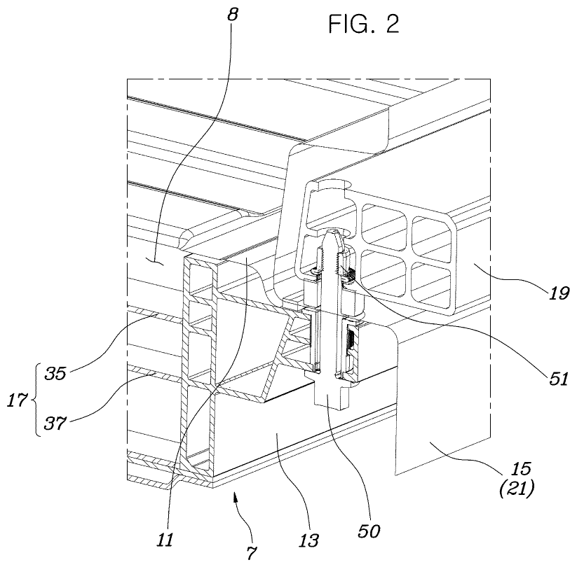

FIG. 2 is a view showing a vehicle, to which the present disclosure is applied, through a cross-section taken along line II-II in FIG. 1. Referring to FIG. 2, a battery side member 13 of the lower case 9 is coupled to a side seal 15, and a transverse member 17 is provided within the lower case 9 to extend lengthily in a transverse direction of the vehicle body, partitioning the battery modules 5 while securing stiffness of the lower case 9.

A side seal reinforcement 19 made of an extruded material is provided within the side seal 15. In FIG. 2, a side seal external panel forming the side seal 15 is omitted, and only a side seal internal panel 21 is shown.

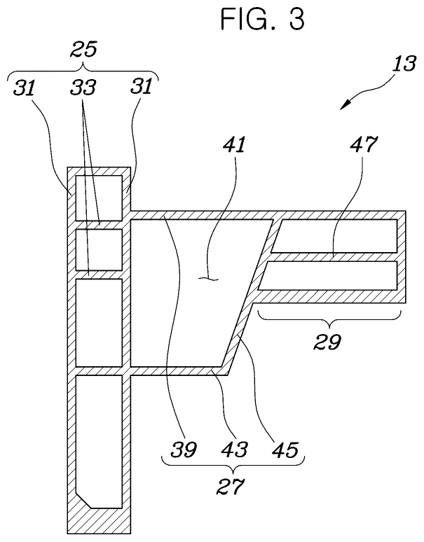

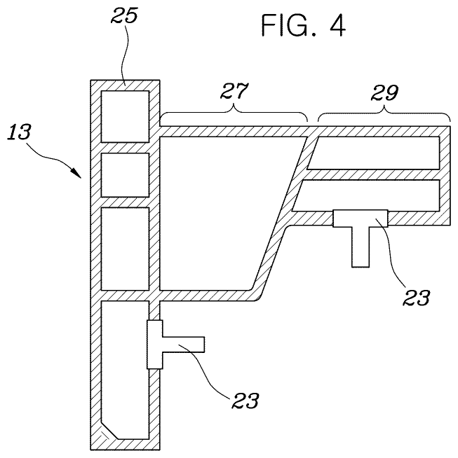

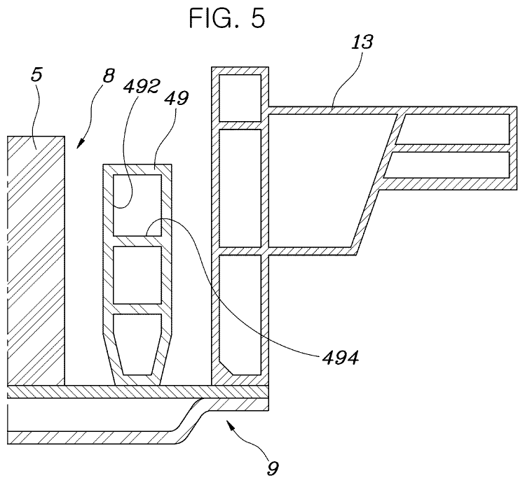

FIG. 3 shows a cross-section of the battery side member 13 of FIG. 2 according to an exemplary embodiment of the present disclosure. FIG. 4 is a view explaining mounting of a conduit mounting mechanism 23 to the battery side member 13. FIG. 5 is a view explaining a modified embodiment of the lower case 9 according to an exemplary embodiment of the present disclosure.

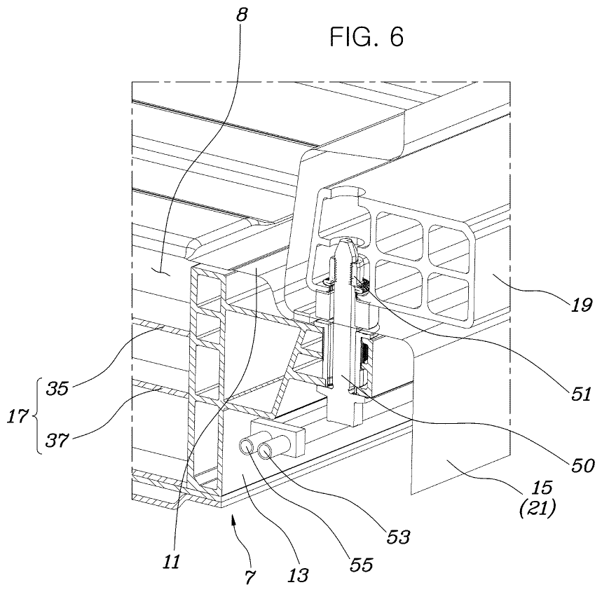

Furthermore, FIG. 6 is a view exemplarily illustrating a state in which a conduit is added to the configuration of FIG. 2.

Referring to FIGS. 1 to 6, in accordance with an exemplary embodiment of the present disclosure, the battery case 7 includes the battery side member 13 provided to surround a side portion of the battery accommodation space 8 formed by the lower case 9. The battery side member 13 includes a side wall portion 25 configured to surround the side portion of the battery accommodation space 8, a first-step protrusion 27 protruding outwards from an upper portion of the side wall portion 25, and a second-step protrusion 29 protruding outwards from an upper portion of the first-step protrusion 27.

In the exemplary embodiment of the present disclosure, the lower case 9 is configured to surround a lower portion and the side portion of the battery accommodation space 8. The function of surrounding the side portion of the battery accommodation space 8 is achieved by the battery side member 13. As described above, the battery side member 13 includes the side wall portion 25, the first-step protrusion 27, and the second-step protrusion 29.

The battery side member 13 is formed by a member having a cross-section formed by the side wall portion 25, the first-step protrusion 27, and the second-step protrusion 29, to extend uniformly linearly.

That is, as shown in the drawings, the battery side member 13 may be formed by an extruded material including a shape in which a single cross-section formed by the side wall portion 25, the first-step protrusion 27, and the second-step protrusion 29 extends uniformly linearly.

In the instant case, upward protrusion of the first-step protrusion 27 from the upper portion of the side wall portion 25 may be understood as outward protrusion of a cross-section of the first-step protrusion 27 in a state in which the cross-section is upwardly inclined from a center line of the side wall portion 25 when viewed in an upward/downward direction of the side wall portion 25. Furthermore, upward protrusion of the second-step protrusion 29 from the upper portion of the first-step protrusion 27 may be understood as outward protrusion of a cross-section of the second-step protrusion 29 in a state in which the cross-section is upwardly inclined from a center line of the first-step protrusion 27 when viewed in an upward/downward direction of the first-step protrusion 27.

The side wall portion 25 includes a cross-section formed by a plurality of ribs 33 disposed among a plurality of vertical walls 31 while being spaced from one another in the upward/downward direction thereof. The side wall portion 25 is configured to substantially seal the battery accommodation space 8 while surrounding the side portion of the battery accommodation space 8.

Meanwhile, the transverse member 17 is provided at the lower case 9 to extend across the battery accommodation space 8 in a transverse direction thereof. A portion of the ribs 33 of the side wall portion 25 is disposed at a level aligned with the transverse member 17.

In the exemplary embodiment of the present disclosure, the transverse member 17 includes a top wall 35, and an intermediate rib 37 spaced from the top wall 35 in a downward direction while being parallel to the top wall 35. A portion of the ribs 33 of the side wall 35 is disposed at levels aligned with the top wall 35 and the intermediate rib 37 of the transverse member 17, respectively.

Accordingly, collision force input from a lateral side of the vehicle when a lateral collision accident of the vehicle or the like occurs may be firmly supported by the rib structures aligned as described above.

The first-step protrusion 27 includes an upper horizontal wall 39 protruding from one vertical wall 31 of the side wall portion 25 in a horizontal direction, a lower horizontal wall 43 spaced from the upper horizontal wall 39 in the downward direction to form a deformation absorption space 41 therebetween, and an intermediate wall 45 configured to interconnect an end portion of the upper horizontal wall 39 and an end portion of the lower horizontal wall 43.

The deformation absorption space 41 includes a void space not provided with any structure such as a rib or the like. Accordingly, the upper horizontal wall 39 and the lower horizontal wall 43 of the first-step protrusion 27 may be relatively easily deformed, as compared to the vertical walls 31 and the second-step protrusion 29, and, accordingly, the first-step protrusion 27 may be configured to absorb deformation caused by impact.

In the exemplary embodiment of the present disclosure, the intermediate wall 45 is formed to be inclined so that the intermediate wall 45 extends toward the side wall portion 25 while extending from an upper end portion thereof to a lower end portion thereof.

Furthermore, the lower horizontal wall 43 is disposed at a level aligned with the intermediate rib 37 of the transverse member 17.

Accordingly, in accordance with the exemplary embodiment of the present disclosure, a load path extending along the intermediate wall 45, the lower horizontal wall 43, the rib 33 of the side wall portion 25, and the intermediate rib 37 of the transverse member 17 is formed to absorb impact force input from a lateral side of the vehicle via the second-step protrusion 29. Thus, a more effective impact support structure is realized.

Meanwhile, the second-step protrusion 29 is formed to protrude from the intermediate wall 45 in the horizontal direction and includes at least one reinforcement rib 47 disposed in the second-step protrusion 29.

Accordingly, when impact force is input via the second-step protrusion 29 in accordance with occurrence of an accident such as lateral collision of the vehicle or the like, the second-step protrusion 29 induces deformation of the first-step protrusion 27 while supporting the impact force, and, accordingly, the first-step protrusion 27 is configured to absorb collision energy while being deformed, consuming the collision energy.

Of course, the side wall portion 25 is configured to maintain the shape thereof while preventing impact force from outside from being transmitted to an interior of the battery accommodation space 8. For the present function, the rib 33 of the side wall portion 25 may be provided in plural.

Meanwhile, a modified embodiment of the lower case 9 according to an exemplary embodiment of the present disclosure is shown in FIG. 5. An additional side wall 49 is provided inside the side wall portion 25 of the battery side member 13. The additional side wall 49 is spaced from the side wall portion 25.

The present configuration is provided to more securely protect the battery modules 5 in the battery case 7 by the additional side wall 49 to cope with the case in which the side wall portion 25 of the battery side member 13 is also deformed.

Similarly to the side wall portion 25 of the battery side member 13, the additional side wall 49 may include a plurality of vertical walls 492, and a plurality of ribs 494 disposed among the plurality of vertical walls while being spaced from one another in the upward/downward direction thereof.

Referring to FIGS. 4 and 6, a conduit mounting mechanism 23 for cables and a conduit is mounted to a lower portion of the second-step protrusion 27 of the battery side member 13 or the side wall portion 25 under the first-step protrusion 27.

The conduit mounting mechanism 23 may be a simple mechanism such as a bolt, a clip, or the like. The cables and the conduit supported by the conduit mounting mechanism 23 may be a brake pipe 53, a cooling pipe 55, etc.

In a conventional case, the cables and the conduit as described above are typically disposed in a space between the battery side member 13 of the battery case 7 and the side seal 15. In in accordance with the present disclosure, however, it may be possible to mount the cables and the conduit to the lower portion of the second-step protrusion of the battery side member 13 or the side wall portion 25 under the first-step protrusion 27. Accordingly, the battery side member 13 may be disposed in a state of being substantially further moved toward the side seal 15 than that of the conventional case.

As a result, the battery accommodation space 8 in the battery case 7 is substantially enlarged, and accordingly, an increased number of battery cells may be mounted in the battery case 7. Consequently, an increase in driving range of the vehicle may be achieved.

Meanwhile, an electric vehicle structure using the above-described battery case 7 in accordance with an exemplary embodiment of the present disclosure includes the lower case 9 including the battery side member 13 having the cross-section formed by the side wall portion 25 configured to surround the side portion of the battery accommodation space 8, the first-step protrusion 27 protruding outwards from the upper portion of the side wall portion 25, and the second-step protrusion 29 protruding outwards from the upper portion of the first-step protrusion 27, the cross-section extending uniformly linearly, and a battery mounting bolt 50 coupled to the side seal 15 while extending through the second-step protrusion 29 of the battery side member 13.

That is, as illustrated in FIG. 2, the second-step protrusion 29 of the battery side member 13 in the lower case 9 is mounted to the side seal 15 by the battery mounting bolt 50.

A side seal reinforcement 19 is mounted within the side seal 15. The battery mounting bolt 50 is coupled to the side seal reinforcement 19 through a mounting nut 51.

As shown in the drawings, the side seal reinforcement 19 may be formed by an extruded material including a plurality of closed cross-sections therein.

Accordingly, impact force input from outside when a lateral collision accident of the vehicle occurs is transmitted to the battery side member 13 after being primarily supported and damped by the side seal 15 and the side seal reinforcement 19. Accordingly, it may be possible to more firmly protect battery modules 5 in the battery accommodation space 8.

Furthermore, the second-step protrusion 29 of the battery side member 13 is disposed under the side seal reinforcement 19 to overlap with the side seal reinforcement 19 in an upward/downward direction thereof. The battery mounting bolt 50 is coupled to the side seal reinforcement 19 while extending through the second-step protrusion 29. A lower end portion of the second-step protrusion 29 is disposed at a higher level than that of a lower end portion of the first-step protrusion 27 so that a head of the battery mounting bolt 50 is disposed at a higher level than that of the lower end portion of the first-step protrusion 27.

Accordingly, the head of the battery mounting bolt 50 does not protrude into a space formed under the first-step protrusion 27. Accordingly, it may be possible to secure a sufficient space in which cables, a conduit, etc. Such as the brake pipe 53, the cooling pipe 55, etc. may be disposed under the condition that the battery side member 13 may be disposed in a state of being further moved toward the side seal 15 than that of the conventional case.

The lower case 9 is coupled to the vehicle body floor panel 11 under the vehicle body floor panel 11 so that the vehicle body floor panel 11 covers an upper side of the battery accommodation space 8. Accordingly, the vehicle body floor panel 11 forms a vehicle body according to the CTV design.

Opposite lateral end portions of the vehicle body floor panel 11 are coupled between at least one of the first-step protrusion 27 and the second-step protrusion 29 of the battery side member 13 and the side seal 15 while overlapping therewith.

Furthermore, a sealer for watertightness is coated over an area where the lateral end portions of the vehicle body floor panel 11 are disposed between the battery side member 13 and the side seal 15 while overlapping therewith. Accordingly, it may be possible to achieve both sealing for an internal space defined over the vehicle body floor panel 11 and sealing for the battery accommodation space 8 under the vehicle body floor panel 11.

As apparent from the above description, in accordance with the present disclosure, it may be possible to not only increase the number of battery cells accommodated in the battery case, achieving an increase in driving range of the vehicle, but also to efficiently absorb collision energy generated when a lateral collision accident of the vehicle or the like occurs, effectively protecting the battery cells accommodated in the battery case.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery case comprising:
a battery side member surrounding a side portion of a battery accommodation space formed by a lower case,
wherein the battery side member includes:
a side wall portion surrounding the side portion of the battery accommodation space;
a first-step protrusion protruding outwards from an upper portion of the side wall portion; and
a second-step protrusion protruding outwards from an upper portion of the first-step protrusion.

2. The battery case of claim 1, wherein the battery side member is formed by a member having a cross-section formed by the side wall portion, the first-step protrusion, and the second-step protrusion, to extend uniformly linearly.

3. The battery case of claim 2, wherein the side wall portion includes a cross-section formed by a plurality of ribs disposed between a plurality of vertical walls while being spaced from one another in a first direction.

4. The battery case of claim 3,
wherein a transverse member is provided at the lower case to extend across the battery accommodation space in a second direction; and
wherein a portion of the ribs of the side wall portion is disposed at a level aligned with the transverse member.

5. The battery case of claim 4,
wherein the transverse member includes a top wall, and an intermediate rib spaced from the top wall in the first direction while being parallel to the top wall; and
wherein a portion of the ribs of the side wall is disposed at levels aligned with the top wall and the intermediate rib of the transverse member, respectively.

6. The battery case of claim 5, wherein the first-step protrusion includes:
an upper horizontal wall protruding from a vertical wall of the side wall portion among the plurality of vertical walls in the second direction;
a lower horizontal wall spaced from the upper horizontal wall in the first direction to form a deformation absorption space therebetween; and
an intermediate wall configured to interconnect an end portion of the upper horizontal wall and an end portion of the lower horizontal wall.

7. The battery case of claim 6, wherein the intermediate wall is formed to be inclined so that the intermediate wall extends toward the side wall portion while extending from an upper end portion of the intermediate wall to a lower end portion of the intermediate wall.

8. The battery case of claim 6, wherein the lower horizontal wall is disposed at a level aligned with the intermediate rib of the transverse member.

9. The battery case of claim 6,
wherein the second-step protrusion is formed to protrude from the intermediate wall in the second direction, and
wherein the second-step protrusion includes at least one reinforcement rib disposed in the second-step protrusion.

10. The battery case of claim 3,
wherein an additional side wall is provided inside the side wall portion; and
wherein the additional side wall includes a plurality of vertical walls, and a plurality of ribs disposed between the plurality of vertical walls while being spaced from one another in the first direction.

11. The battery case of claim 2, wherein a conduit mounting mechanism for cables and a conduit is mounted to a lower portion of the second-step protrusion or the side wall portion under the first-step protrusion.

12. An electric vehicle structure comprising:
a lower case including a battery side member having a cross-section formed by a side wall portion surrounding a side portion of a battery accommodation space, a first-step protrusion protruding outwards from an upper portion of the side wall portion, and a second-step protrusion protruding outwards from an upper portion of the first-step protrusion, the cross-section extending uniformly linearly; and
a battery mounting bolt coupled to a side seal while extending through the second-step protrusion of the battery side member.

13. The electric vehicle structure of claim 12,
wherein a side seal reinforcement is mounted within the side seal; and
wherein the battery mounting bolt is coupled to the side seal reinforcement.

14. The electric vehicle structure of claim 12, wherein the lower case is coupled to a vehicle body floor panel under the vehicle body floor panel so that the vehicle body floor panel covers an upper side of the battery accommodation space.

15. The electric vehicle structure of claim 14, wherein opposite lateral end portions of the vehicle body floor panel are coupled between at least one of the first-step protrusion and the second-step protrusion of the battery side member and the side seal while overlapping therewith.

16. The electric vehicle structure of claim 15, wherein a sealer for watertightness is coated over an area where the opposite lateral end portions of the vehicle body floor panel are disposed between the battery side member and the side seal while overlapping therewith.

17. The electric vehicle structure of claim 12, wherein a conduit mounting mechanism for cables and a conduit is mounted to a lower portion of the second-step protrusion or the side wall portion under the first-step protrusion.

18. The electric vehicle structure of claim 12, wherein the first-step protrusion of the battery side member includes:
an upper horizontal wall protruding from a vertical wall of the side wall portion in a first direction;
a lower horizontal wall spaced from the upper horizontal wall in a second direction to form a deformation absorption space therebetween; and
an intermediate wall configured to interconnect an end portion of the upper horizontal wall and an end portion of the lower horizontal wall.

19. The electric vehicle structure of claim 18,
wherein the second-step protrusion of the battery side member is formed to protrude from the intermediate wall in the first direction, and
wherein the second-step protrusion includes at least one reinforcement rib disposed in the second-step protrusion.

20. The electric vehicle structure of claim 19, wherein the intermediate wall of the battery side member is formed to be inclined so that the intermediate wall extends toward the side wall portion while extending from an upper end portion of the intermediate wall to a lower end portion of the intermediate wall.
